(19) United States
(12) Patent Application Publication
(10) Pub. No.: US 2013/0050931 A1
(43) Pub. Date: Feb. 28, 2013

(54) SYSTEM AND METHOD FOR COOLING A PROCESSING SYSTEM

(71) Applicants: Peter Heiland, Raunheim (DE); Andreas Birkner, Jena (DE)

(72) Inventors: Peter Heiland, Raunheim (DE); Andreas Birkner, Jena (DE)

(21) Appl. No.: 13/516,036

(22) PCT Filed: Dec. 14, 2010
(86) PCT No.: PCT/EP10/07685

§ 371 Date: Sep. 24, 2012

(30) Foreign Application Priority Data
Dec. 14, 2009 (DE) 10 2009 058 055.7
Jul. 6, 2010 (DE) 10 2010 026 297.8

(51) Int. Cl. G06F 1/20; G06F 1/16

(52) U.S. Cl. 361/679.33; 361/679.53; 361/679.47

(57) ABSTRACT

The invention relates to a system for cooling a computing system, wherein waste heat of the computing system is supplied as driving energy to a refrigeration machine for cooling the computing system.

### FIELD OF THE INVENTION

The invention relates to a system and a method for cooling a computing system, in particular for cooling a server farm.

### BACKGROUND OF THE INVENTION

Computing systems, in particular server farms that comprise a large number of racks, generate large amounts of heat during operation. For example, a server farm typically has a pure heat output of several kilowatts. Generally, air conditioners are used to discharge these large amounts of heat, the operation of which is very energy intensive.

Two approaches are known from practice which attempt to use the waste heat of a computing system to heat a building. However, often such an approach is not feasible for lack of heated building surfaces in the proximity, and, depending on the climate zone and season, not suitable to provide for adequate cooling of an existing computing system in an building. Moreover, in the summer heating energy for heating buildings is often not required.

It is estimated that the energy needed for server farms will increase up to 100 GWh or more in the next few years, with up to 40% of this energy being attributed to cooling alone.

Conventional computing systems are usually cooled through the air conditioning of the room, the individual computers emitting heat to the ambient air via a fan.

But there are also newer approaches in which the racks of a computing system are cooled by a liquid, the cooling air of the racks transferring its heat energy, via a heat exchanger integrated in or adapted to the rack, to a liquid to be cooled outside the rack.

Another approach is to discharge the heat energy directly from the processors, through a liquid cooling circuit. This method, though it has the advantage that a majority of the generated heat can be discharged from a small local volume, has not yet been implemented in practice, at least not on an industrial scale, possibly due to the fact that the technical difficulties associated with liquid cooling of processors, such as sufficiently ensuring tightness, are still in no reasonable proportion to the benefits.

In view of the further increasing computing power in less and less space it can be assumed that the cooling load and associated energy consumption will also increase.

### OBJECT OF THE INVENTION

Therefore, the invention is based on the objective to reduce the energy requirements of a conventional cooling system for computing systems.

This should be realized without necessarily relying on site-dependent external sources.

### DESCRIPTION OF THE INVENTION

The object of the invention is already achieved by a system for cooling a computing system and a method for cooling a computing system according to any of the independent claims.

Preferred embodiments and refinements of the invention are set forth in the respective dependent claims.

The invention, on the one hand, relates to a system for cooling a computing system. A computing system is understood as an arrangement including a plurality of computers, in particular a data processing center or a server farm. Usually such a computing system has a modular structure in which racks are provided in which the individual circuit boards and/or assemblies are arranged, in particular plugged-in.

The system is in particular intended to cool computing systems whose heat dissipation amounts to more than 5 kW, preferably more than 50 kW.

The system comprises a refrigeration machine by which a fluid can be cooled that can be supplied to the computing system. Preferably, air or a liquid, in particular water, is supplied to cool the computing system. But it is also conceivable to directly supply a refrigerant that is used in the refrigeration machine to the computing system.

Cooling by air is usually accomplished by cooling the room in which the individual computers are installed, and/or by having the computers provided with its own internal air cooling, which then emits waste heat to the ambient air and so the waste heat is discharged via the ambient air which is held within a predetermined target temperature range.

In systems with greater processing power when using air cooling, in most cases there is provided an air cooling system for each rack, which means that the heat is not only discharged through the ambient air of the room, but air is directly passed through or blown into the racks, so enabling more local heat dissipation. Feed flow temperatures of the cooling air that are required for such a rack cooling system will vary in function of the performance and technical configuration of the computing system, for example the feed flow temperature of the cooling air may range from 20° C. to 25° C.

Another possibility of implementation is liquid cooling of racks. Liquid cooling of racks normally works with a lower feed flow temperature; in particular the feed flow temperature of the cooling liquid for rack cooling purposes ranges from 10° C. to 15° C., again varying depending on the performance and technical configuration, to enable the heat exchanger of the cooling liquid based rack cooling system to absorb the heat generated by the individual components. This in turn generally results in a lower return flow temperature which is usually not much above 20° C.

For the technically more complex cooling of processors, by contrast, cooling may be accomplished at higher temperatures. Generally, processors are configured for an operating temperature of up to 100° C., so that feed flow temperatures of up to 50° C. are sufficient to ensure adequate processor recooling. The return flow temperature in processor recooling circuits is quite high and may reach 60° C.

According to the invention, waste heat from the computing system is supplied to the refrigeration machine, through thermal conduction or through a liquid, to supply the refrigeration machine with driving energy.

Therefore, no refrigeration machine is used which is driven via a mechanical compressor, but a refrigeration machine which is operated with heat. Such refrigeration machines are also referred to as a “thermal compressor”. The invention enables to use the waste heat generated in the computing system at least partially for cooling the same. In this way it is possible to achieve significant energy savings.

The supply is accomplished through a liquid which permits a relatively good heat transfer, for example in combination with processor cooling, with a relatively high temperature of the supplied liquid. Alternatively, in particular in embodiments in which the refrigeration machine is integrated into components of the computing system, the heat transfer is accomplished through direct heat transfer. In the context of the invention this includes so-called heat pipes, in which a heat transfer primarily takes place through evaporation and condensation.

Known refrigeration machines which can be operated with thermal energy are sorption refrigeration machines.

On the one hand there are absorption refrigeration machines, among which in particular the water-lithium bromide absorption refrigeration machine can be operated at feed flow temperatures from 80° C. These refrigeration machines are already available on an industrial scale with capacities of several thousand kW.

The use of an absorption refrigeration machine is particularly suitable for the processor cooling described above, since in this case the return flow temperature of the cooling circuit reaches temperatures with which an absorption refrigeration machine can be operated.

Therefore, no or only little additional heating power has to be provided to operate the absorption refrigeration machine.

Furthermore, there are adsorption refrigeration machines that are, for example, operated with zeolites or silica gel as a sorbent medium. An advantage of such refrigeration machines is that they may be operated at significantly lower temperatures. Generally, a feed flow temperature of 50° C. is sufficient.

A disadvantage of the adsorption refrigeration machine is the discontinuous mode, in which the adsorption medium is loaded and unloaded. However, an adsorption refrigeration machine can be operated, for example, at the temperature of the exhaust air from rack cooling. The disadvantage of the necessary bridging of regeneration phases of an adsorption refrigeration machine may be diminished by using a plurality of sorption refrigeration machines, preferably adsorption refrigeration machines and/or a buffer, such that sufficient continuous cooling can be ensured.

In particular when using air cooling it is appropriate to use a refrigeration machine that operates on the principle of cooling by absorptive dehumidification, also commonly referred to as a desiccant cooling system (DCS). In this case warm moist air is dehumidified by sorbents, and is then humidified for adiabatic cooling. The sorbents saturated with water vapor are regenerated by heating. Supply air can thus be cooled, while at the same time the exhaust air is heated. The advantage of such absorptive dehumidification is the relatively low complexity and low regeneration temperature, which is usually below 70° C.

In one embodiment of the invention, the racks and/or processors of the computing system are cooled with a liquid which is directly fed to the refrigeration machine to drive it. This embodiment of the invention is suitable above all in cases where further components for increasing the feed flow temperature to provide the driving energy for the refrigeration machine shall be dispensed with. In particular in case of processor cooling it is conceivable to not interpose any further heat exchangers, but to directly supply the cooling medium to the heat exchanger of the refrigeration machine.

In one alternative embodiment of the invention, the refrigeration machine is connected, via a heat exchanger, with a cooling circuit of the computing system. This principle particularly facilitates retrofitting of the system into an existing cooling system.

In a modification of the invention, a heat pump is provided between the computing system and the refrigeration machine, to increase the feed flow temperature of the refrigeration machine.

It will be understood that the heat pump likewise constitutes a refrigeration machine. For the purposes of the invention, a compression-type refrigeration machine is connected upstream as a heat pump, which is not supplied with heat as the driving energy but relies on an external energy source such as the power grid or a solar system. There are also other physical principles applicable for heat pumps, for example heat pumps working on the principle of magnetocalorics.

By using a heat pump, the temperature of the return flow of the computing system may be brought to a level at which a downstream sorption refrigeration machine achieves good efficiency.

In a preferred embodiment, the cold section, i.e. the evaporator of the heat pump, is connected to the feed flow line of the cold section of the refrigeration machine. Via the warm section, i.e. the condenser of the heat pump, the driving medium for the sorption refrigeration machine is brought to a higher temperature as compared to the return flow of the computing system, and at the same time the feed flow of the cold section of the sorption refrigeration machine is precooled via the cold section of the heat pump.

In one modification of the invention, externally generated heat, in particular from a solar collector, is supplied to the refrigeration machine as additional driving energy. When using a solar system it is therefore conceivable that, depending on the climate zone, even a purely thermal operation of the refrigeration machine without any use of photovoltaics is possible. However, it is also conceivable to first supply the heat generated by a thermal solar collector to a heat pump, together with the return flow of the computing system, to further increase the temperature thereof.

In one modification of the invention, the system comprises at least one, preferably two buffer storage tanks. Besides the use of buffer storages in conjunction with an adsorption refrigeration machine as described above, buffer storages permit to ensure appropriate emergency cooling in case of failure of individual components.

Furthermore, for example when using a buffer storage in the feed flow of the refrigeration machine, a sufficient quantity of driving fluid can be provided at the required temperature, since depending on the configuration of the computing system, the return flow temperature or the heat output of the computing system may vary greatly in function of fluctuating loads.

Preferably, one buffer storage tank is provided for storing cold fluids for cooling the computing system, and another buffer storage tank is provided for storing a fluid which serves as a driving fluid for the refrigeration machine.

If a further refrigeration machine is used to raise the temperature of the driving fluid of a sorption refrigeration machine, a buffer storage tank may also be arranged between the sorption refrigeration machine and the further refrigeration machine.

Furthermore, as is the case in one modification of the invention, the system may include means for selectively distributing the cooling fluid within the computing system.

In particular it is suggested to distribute the cooling power within the computing system as needed in function of the workload. To optimize coolant distribution, as provided for in one embodiment of the invention, the system for cooling the computing system may itself be interfaced with the computing system. For example it is conceivable that at least individual ones of the servers of the computing system report their specific workload and/or their respective temperature, via an interface, to control electronics of the cooling system, so that the cooling system is not only controlled through feed flow and return flow temperatures but in function of the load. The benefit of such a control systems is based, among other things, on the fact that at a very early stage, i.e. directly upon an increase of the load of the computing system, additional cooling power is requested.

In contrast to simpler control systems that are controlled for example based on the return flow temperature, the cooling system in case of lower utilization of the computing system may be operated at significantly reduced power, without the risk that in the event of a sudden increase in workload individual components are overheated due to the low cooling power supplied.

A temperature monitoring program running in the background may be installed on individual ones of the computers for controlling the computing system, which program upon increasing cooling requirements passes this information to the controller of the cooling system. An interface that can be used in the context of the present example may be an already existing LAN port.

Likewise conceivable is to remotely monitor and/or control the cooling system via a network, in particular based on the internet.

According to one embodiment of the invention, the control is adapted such that, if possible, heat may be discharged to the environment, for example to a heat exchanger arranged outside, or within a heating system to the heating of the building. An advantage of this type of cooling which is also referred to as “free cooling” is that part of the heat can be dissipated without the complex and potentially energy intensive operation of a refrigeration machine.

In particular, it is suggested to discharge process heat from a sorption refrigeration machine into the environment, or to further cool down fluid which leaves the hot section of a sorption refrigeration machine with still relatively high temperature, in the environment, before this fluid is supplied to the computing system itself or to the cold section of the refrigeration machine.

In a preferred embodiment of the invention, the system comprises at least redundantly configured pumps for distributing the cooling fluid, and/or a redundantly configured refrigeration machine. At least in larger server farms, even in an event of failure of individual components a permanent supply with cooling fluid has to be ensured for a longer period, for which purpose buffer storage tanks usually are not sufficient.

For emergency cooling, an additional conventional refrigeration compressor or a supply of cold tap water into the system may be provided, for example.

In one modification of the invention, the system may be integrated into an existing air conditioning and/or hot water supply of a building. For example it is conceivable for the process heat generated in a sorption refrigeration machine to be used, at least partially, to heat the building and/or for hot water supply. It is also conceivable to use the process heat to generate electricity, for example by means of Peltier elements.

In a preferred embodiment of the invention, the system has a modular configuration and comprises at least one cooling module in which at least the refrigeration machine and an electronic controller is arranged. In particular it is intended to provide a module which comprises a housing having ports to which in addition to a power supply and the connection of the computing system via an interface, where appropriate, feed and return lines of the cooling system for the computing system may be connected. Furthermore the module preferably comprises ports for an external heat exchanger through which process heat of the refrigeration machine is discharged.

The controller of the system for cooling a computing system is also integrated in the module.

In a preferred embodiment of the invention, the module furthermore has at least one autonomous emergency power supply, through which at least the operation of the pumps which supply the cooling fluid to the computing system is ensured in the event of power failure. It is also conceivable to connect at least one control electronics of the cooling system with the emergency power supply. For more simple controlling it is also possible to control the pumps such that they continue to work when the control electronics is switched off.

Alternatively, an emergency power supply of the cooling system may be ensured via an emergency power supply of the computing system, in particular via an uninterruptible power supply.

Computing systems generally have an uninterruptible power supply. Such uninterruptible power supplies of computing systems are usually cooled as well. It is therefore intended to use the cooling system also for the uninterruptible power supply. An uninterruptible power supply usually comprises at least accumulator batteries that can bridge short-term interruptions of the mains voltage. The uninterruptible power supply usually starts within a few milliseconds, so that even short-term voltage disturbances are compensated for.

A computing system usually also includes telecommunications equipment such as modules for connecting to a telecommunications network. It goes without saying that the cooling system according to the invention, if necessary, also ensures the cooling of these telecommunication modules.

According to one embodiment of the invention, cascaded cooling systems are provided, in particular to increase the cooling capacity, and/or for a redundant configuration. In this case, a plurality of cooling systems is connected in series, such that the temperature of the cooling fluid is reduced in individual cooling steps. Different refrigeration machines may be used which are adapted to the respective cooling step.

According to the invention, the computing system itself can be cooled through the refrigeration machine, that means preferably a predominant part of the low temperature fluid produced by the refrigeration machine is used to cool the computing system itself.

In one preferred embodiment of the invention, a hot section of the refrigeration machine is connected with the computing system via a first circuit, for supplying driving energy, and the cold section of the refrigeration machine is connected to another cooling circuit of the computing system.

For example, the hot section of the refrigeration machine may be connected with processors of the computing system, or with processors, other components such as telecommunications modules or components thereof, etc., via a liquid cooling circuit. This first cooling circuit supplies the refrigeration machine with driving energy.

The cold section of the refrigeration machine may be connected, via an air and/or liquid cooling circuit, with the rack or the servers themselves, for example. So the circuit of the cold section which is separately connected has a substantially lower temperature, and in the hot section which operates at a relatively high temperature operation is enabled both at high temperature and with a high ΔT between the hot section and the cold section of the refrigeration machine. For example in case of a processor cooling circuit, the return flow from the computing system may have a temperature of about 60° C.

This high temperature is now first used to operate the sorption refrigeration machine, and, due to the still relatively high temperature, may be cooled further down without difficulty, for example by outside heat exchangers, to be then re-supplied to the hot circuit of the computing system.

In one embodiment of the invention, the fluid which supplies the refrigeration machine with driving energy, is cooled after leaving the refrigeration machine. Due to the still relatively high temperature this is usually accomplished without refrigeration machine, but for example by means of heat exchangers, in particular also for heating purposes. In this way, thermal energy is extracted from the entire system without the need to operate a refrigeration machine for this purpose. At the same time, the sorption refrigeration machine can be operated with a high ΔT.

In one preferred embodiment, the target feed flow temperature of a first cooling circuit which also provides the driving energy differs from the feed flow temperature of a further cooling circuit by at least 10° C., preferably by at least 20° C.

In one modification of the invention, a section of the refrigeration machine through which process heat can be discharged, is connected to the heating system of a building.

This embodiment of the invention is based on the conclusion that process heat which has a temperature above 30° C. can be used for heating purposes, at least in low-temperature circuits of a building, or to produce hot water or energy, for example.

The system may have at least two coolant connections each one comprising feed flow line and return flow line, which are connected to the computing system. If multiple cooling circuits are used it is possible to provide different circuits with different target feed flow temperatures adapted to the respective type of cooling. For example, a liquid based cooling circuit with a relatively high feed flow temperature, e.g. of more than 50° C., may be coupled with the processors.

Another cooling circuit may be coupled with the circuit boards of the servers, for example also by means of a liquid.

By contrast, a closed air based cooling circuit which is coupled with each of the racks and connected to the cold circuit of the cold section of the refrigeration machine, works at a much lower feed flow target temperature, e.g. below 30° C.

The feed flow temperature of a first circuit preferably differs from the feed flow temperature of a further cooling circuit by at least 10° C., preferably by 20° C.

In a preferred embodiment of the invention, one cooling circuit is operable with a liquid such as water, and another cooling circuit is operable with a gas such as air.

In one modification of the invention, the refrigeration machine is integrated into a rack or into a server. In this way, in particular sorption refrigeration machines may be accommodated locally in the system. Also, a server may cool itself in this way, for example. Each cooling circuit may be optimized for the respective associated device. A connection for a cooling circuit, in the sense of the invention, is understood as any possible type of interface through which heat energy can be transferred.

Also, as is suggested according to another embodiment of the invention, the sorption refrigeration machine may be arranged immediately adjacent to the server or the rack. For example, the sorption refrigeration machine may be provided above or below a server or rack. Thus, no additional footprint area is required.

Thermal energy may for example be exchanged via direct thermal communication of a cooling liquid with components of the refrigeration machine and components of the computing system.

Furthermore, the heat energy may for example also be transferred via heat conductive solids such as aluminum or copper, or also by heat pipes in which the heat transfer is accomplished within a closed transfer system through evaporation and condensation processes.

Furthermore, a water to air heat exchanger integrated in the rack may be used, and within the rack a closed air circuit may cool the components of the rack, for example. In another embodiment of the invention, a heat exchanger integrated into the rack or coupled to the rack may be connected, which is supplied with cold that is supplied from the refrigeration machine via a liquid, and which cools air before the air is directed into the rack or before it leaves the rack, without an imperative need to provide a closed circuit within the rack.

A system for cooling a computing machine according to the invention may include a plurality of refrigeration machines, in particular several different refrigeration machines which are optimized to the respective cooling task.

In particular, sorption refrigeration machines which are operated with waste heat of the computing system, may be combined with conventional refrigeration machines, for example to compensate for a lack of cooling capacity.

Preferably, the cooling fluid is selectively distributed by means of controllable valves in a manner to optimize the efficiency of the cooling system. To this end, the system for cooling a computing system may for example comprise a computer which controls the system.

The processor cooling system in the sense of the invention may not only include the main processors of the computing system, rather the processor cooling system may also include additional processors and electronic devices such as memory circuits, hard disks, chip sets, power components of the power supply, which in turn are included in different components of the computing system such as in server racks, telecommunications equipment, power supplies, data storages, and other components of the computing system.

In particular the cooling fluid may be passed through heat exchangers which are in communication with the printed circuit boards and thus cool the circuit boards and/or devices thermally coupled with the circuit board. It is also possible for the cooling fluid to be directed through the circuit boards.

According to another embodiment of the invention, it is suggested to thermally couple heat generating components with each other, in particular processors, so that the number of heat exchangers through which a fluid flows can be reduced. In particular it is intended to thermally couple multiple processors by a so-called “heat pipe”, i.e. an element exhibiting good thermal conduction, and to discharge the heat at some point of the heat pipe.

The invention further relates to a system for cooling, in particular for cooling a computing system as described above, which comprises a refrigeration machine, through which waste heat is supplied as the driving energy via a cooling circuit. In particular a sorption refrigeration machine is provided.

According to the invention, a fluid of the cooling circuit of the hot section, after having passed the hot section, is cooled down by a heat exchanger to be then supplied to the cold section of the refrigeration machine. A particular advantage thereof is that after the high temperature of the fluid has been used as driving energy for the refrigeration machine, the fluid is still warm enough to be fed for example into a heat exchanger of a building heating. Subsequently, the fluid that has further cooled down may be fed to the cold section and can be used for cooling, in particular cooling of a computing system, or for other cooling purposes.

In one embodiment of the invention, the computing system has at least one heating element to heat the fluid in a cooling circuit, in particular in a cooling circuit including a liquid. In particular, this is an electrical heating element. Thus, during low server load periods, for example, the cooling fluid may be heated in order to have a sufficient temperature to be used as driving energy for the refrigeration machine.

The heating elements may for example be arranged in a server or in a rack of the computing system.

In one embodiment of the invention, the sorption refrigeration machine is integrated into a server, in particular into a blade server.

According to one embodiment it is suggested for the sorption refrigeration machine to be configured as a module which is insertable into the server, in particular as a plug-in module. This embodiment of the invention may for example be used for conventional blade servers.

Integration into the server allows for short cable lengths, whereby efficiency is increased. Also, the only external connection required is a fluid connection for discharging process heat. Otherwise, all components may be integrated in the server or rack.

The invention further relates to a method for cooling a computing system, in particular by means of a system for cooling a computing system as described above.

The computing system is cooled with a sorption refrigeration machine, and according to the invention waste heat of the computing system is applied to the sorption refrigeration machine as driving energy.

In one embodiment of the invention, processors and other processing components of the computing system, which also include processors of telecommunications equipment, power supplies, etc. are cooled by means of a liquid which passes through a hot circuit of the sorption refrigeration machine.

Via a cold section of the refrigeration machine, which is preferably coupled with the computing machine via another cooling circuit, the computing system can be cooled. So, a high ΔT may be achieved between the heating circuit and the cooling circuit of the sorption refrigeration machine.

In order to achieve a good efficiency, preferably the temperature of individual components of the computing system is measured, and a cooling fluid is selectively distributed in function of the measured temperatures.

In order to achieve a sufficiently high temperature to drive a sorption refrigeration machine, it is in particular intended to control the entire cooling circuit such that this high temperature is reached continuously. For example, the flow rate of the refrigerant may be reduced during low load periods of the computing system.

It is furthermore suggested to temporarily operate individual branches of the cooling system at a higher temperature so as to achieve a high return flow temperature.

In another embodiment of the invention, the computing system, in particular the processors of the computing system, are temporarily subjected to a higher load using a software. In this manner, during periods of low utilization of the computing system, the feed flow temperature of the hot section of the refrigeration machine may be brought to a sufficiently high temperature to provide the latter with driving energy, without requiring any hardware components for this purpose. Rather, in this software based solution the processors are subjected to a load so that the computing system generates more heat. Furthermore, this also allows to increase the quantity of driving energy for the sorption refrigeration machine. Also, it can be ensured in this way that the minimum required temperature for the operation of the sorption refrigeration machine is reached.

Moreover, efficiency can be improved, since the efficiency also depends on the temperature of the driving energy.

In another embodiment of the invention, the feed flow temperature of the hot section of the refrigeration machine is controllable through a bypass of a cooling circuit of the computing system.

For example, a cooling circuit of a liquid-based processor cooling system is provided with a bypass through which cooling fluid flows past the processors without being cooled by the refrigeration machine. By means of a controllable directional valve it can be controlled, which quantity of liquid flows through the refrigeration machine and which quantity of liquid flows through the bypass. So, for example by using temperature sensors, a constant return flow temperature may be ensure, in order to continuously supply the sorption refrigeration machine with a fluid at a constant temperature or with a temperature within a defined window, while also keeping constant the feed flow temperature. In this manner, constant feed flow and return flow temperatures are achieved independently of the heat output of the processor, which can be of importance for a high efficiency of the sorption refrigeration machine.

### DESCRIPTION OF THE DRAWINGS

### Brief Description of the Drawings

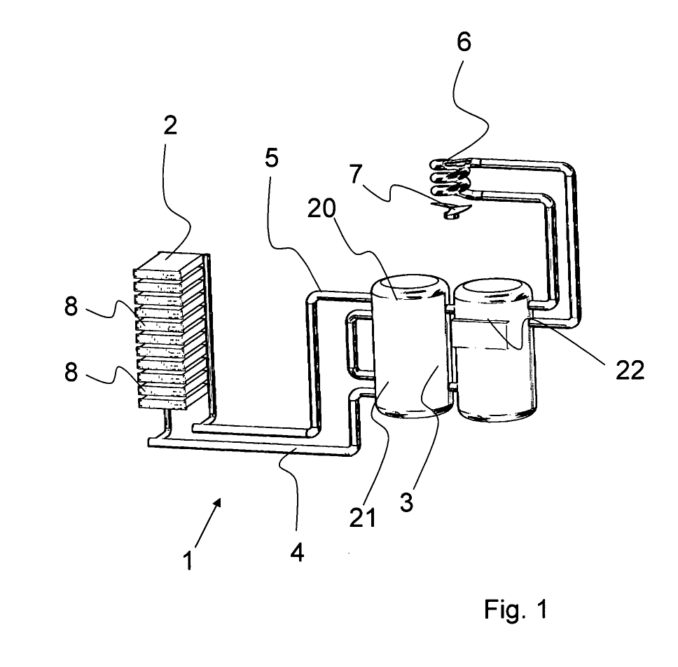

The invention will now be described in detail with reference to the drawings of FIGS. 1 through 17, which schematically illustrate exemplary embodiments of the invention.

FIG. 1 shows an exemplary embodiment of the invention in which the components inserted into a rack are cooled by a processor cooling system and a sorption refrigeration machine.

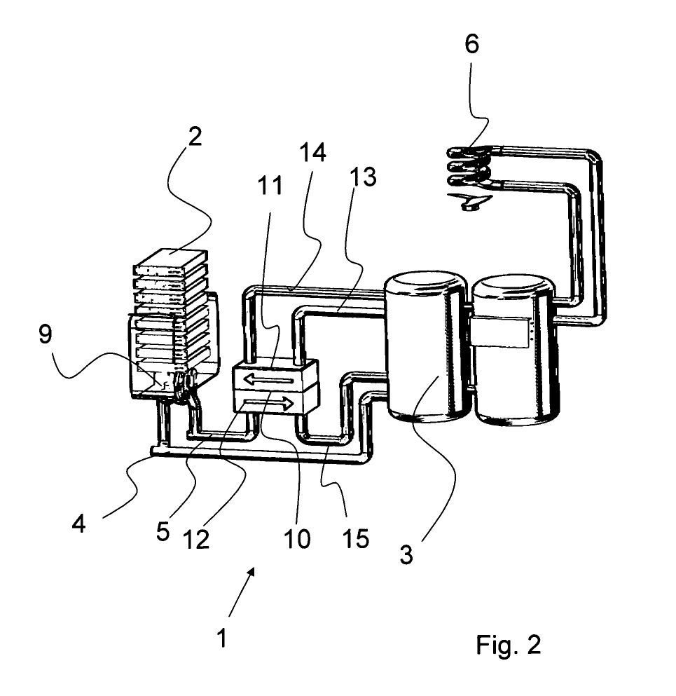

FIG. 2 shows an exemplary embodiment of the invention, in which a heat pump is provided between a liquid cooled rack and a sorption refrigeration machine.

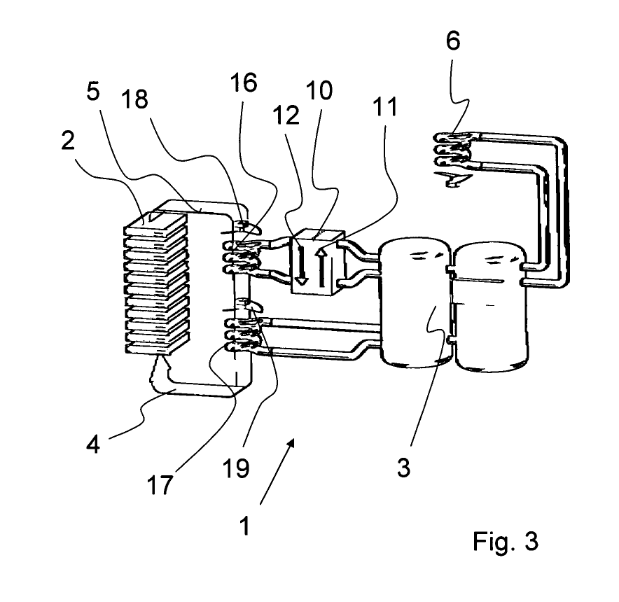

FIG. 3 shows an embodiment of the invention in which the rack is cooled by air and a heat pump is arranged between the computing system and the sorption refrigeration machine.

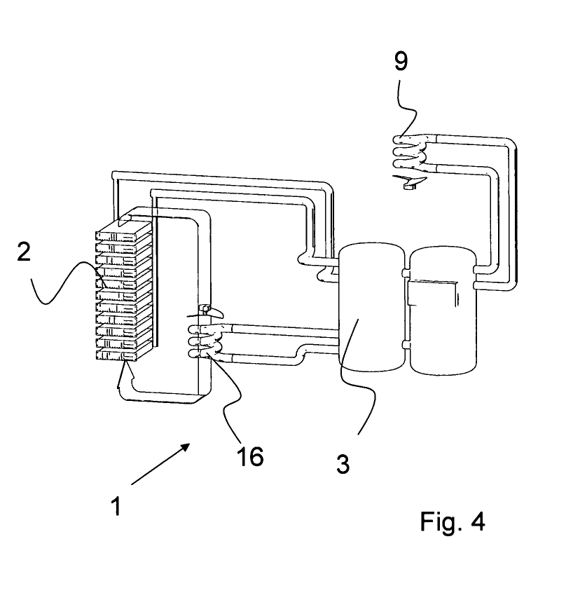

FIG. 4 shows an embodiment of the invention in which the processors are coupled with the refrigeration machine via a liquid cooling system and racks are cooled by air via another cooling circuit.

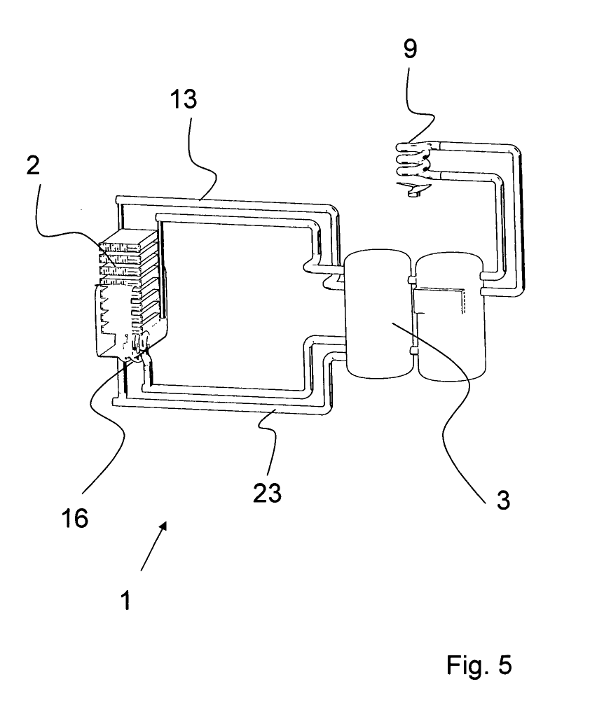

FIG. 5 shows an embodiment of the invention in which a heat exchanger is provided in the racks, which is operated with cooling water and cools the air in the rack.

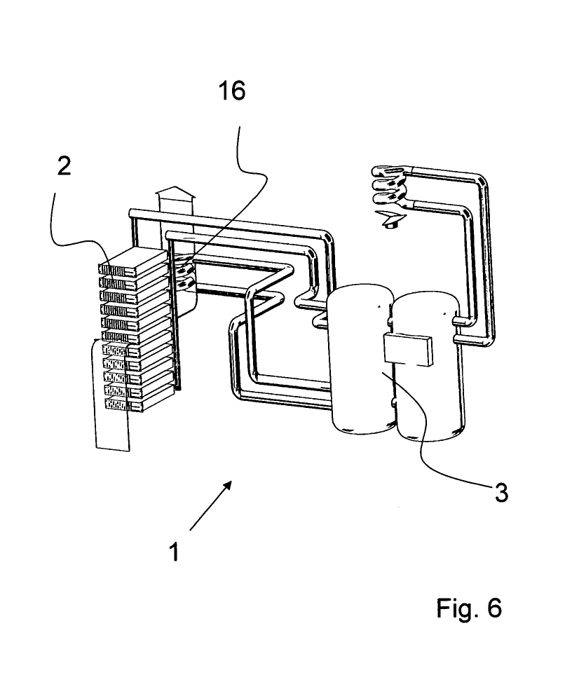

FIG. 6 shows an embodiment of the invention in which the air supplied to the racks is used to cool the environment of the data processing center.

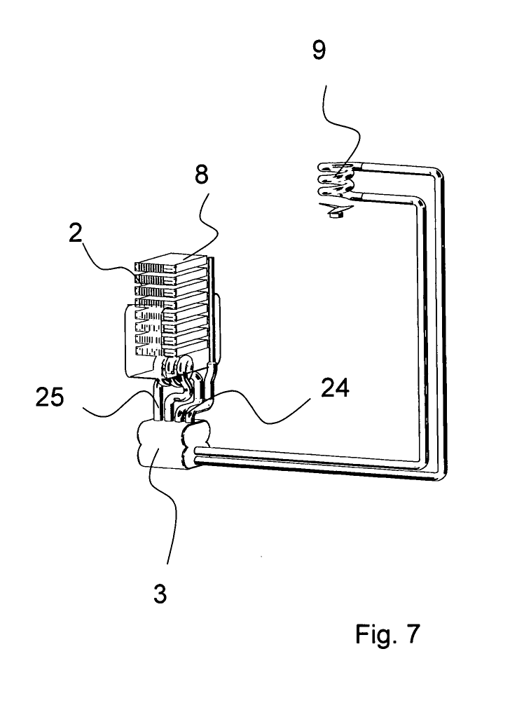

FIG. 7 shows an embodiment of the invention in which the sorption refrigeration machine is integrated into a rack.

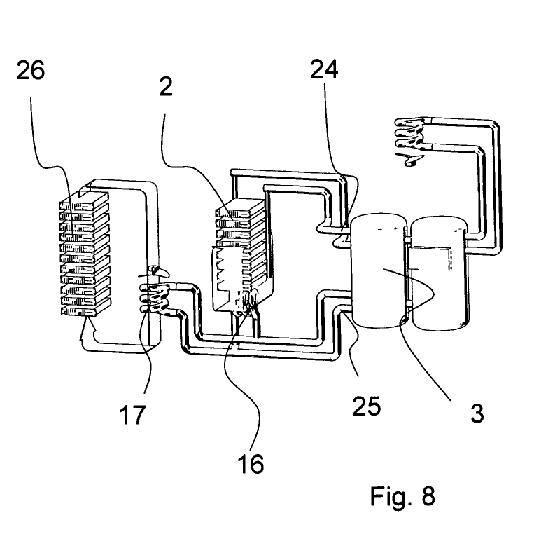

FIG. 8 shows an embodiment of the invention in which liquid cooling of processors is combined with air cooling of a rack and with air cooling of another rack via a heat exchanger.

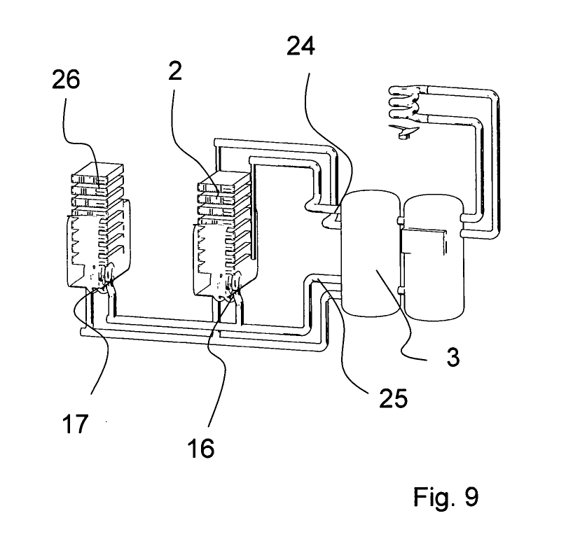

FIG. 9 shows an embodiment of the invention in which the system for cooling a computing system is coupled with another component of a computing system or of a telecommunications system.

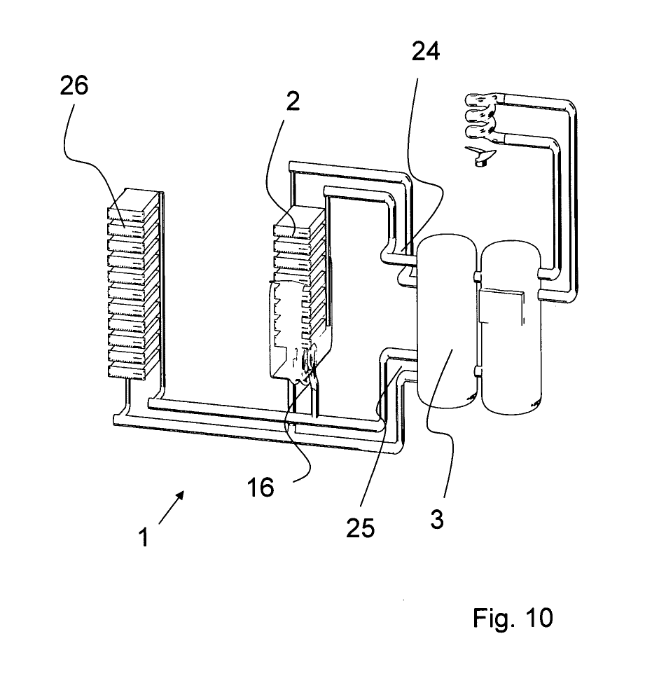

FIG. 10 shows another embodiment of the invention in which components are cooled via two different cooling circuits.

FIG. 11 shows an embodiment of the invention in which the process heat of the refrigeration machine is used for heating purposes.

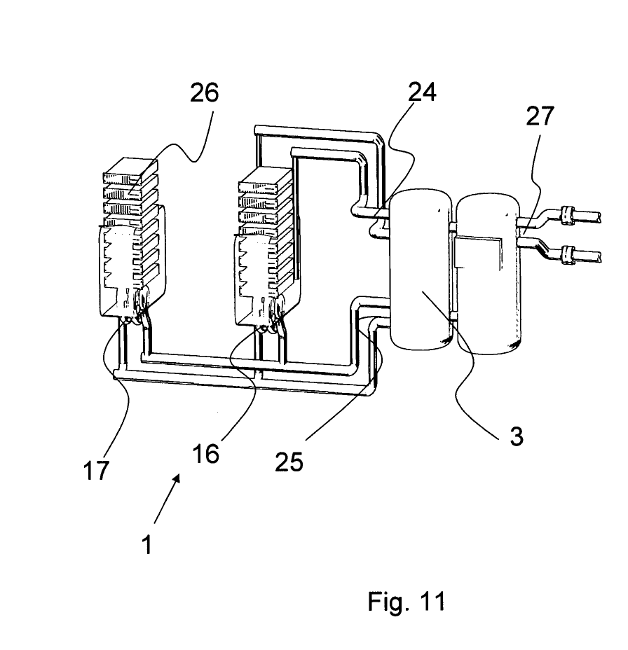

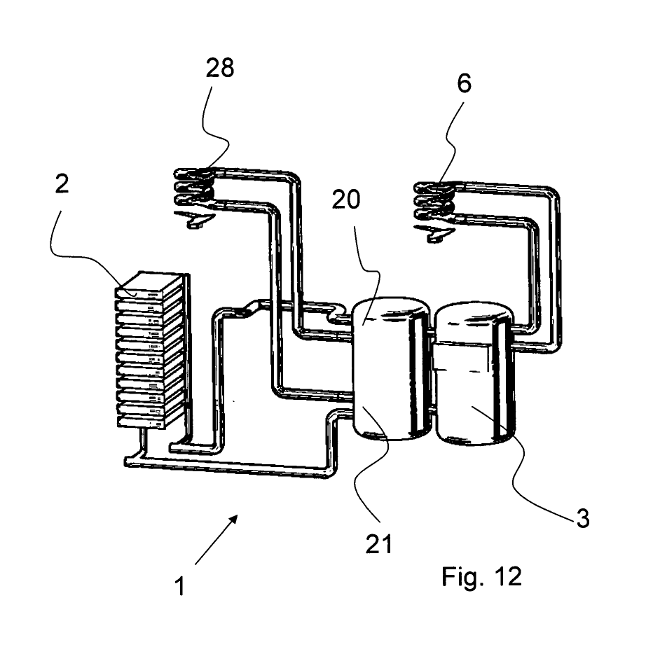

FIG. 12 shows an embodiment of the invention in which the return flow of the hot section of the refrigeration machine is passed via another heat exchanger and is supplied to the cold section of the refrigeration machine.

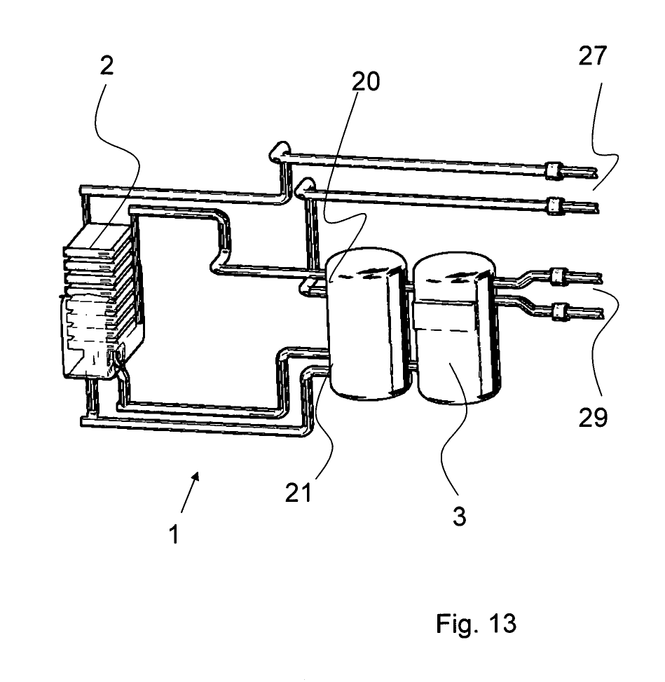

FIG. 13 shows an embodiment of the invention in which the system for cooling a computing system comprises two interfaces for discharging heat.

FIG. 14 shows another embodiment of the invention in which a solar module is integrated into the circuit of the hot section of the refrigeration machine.

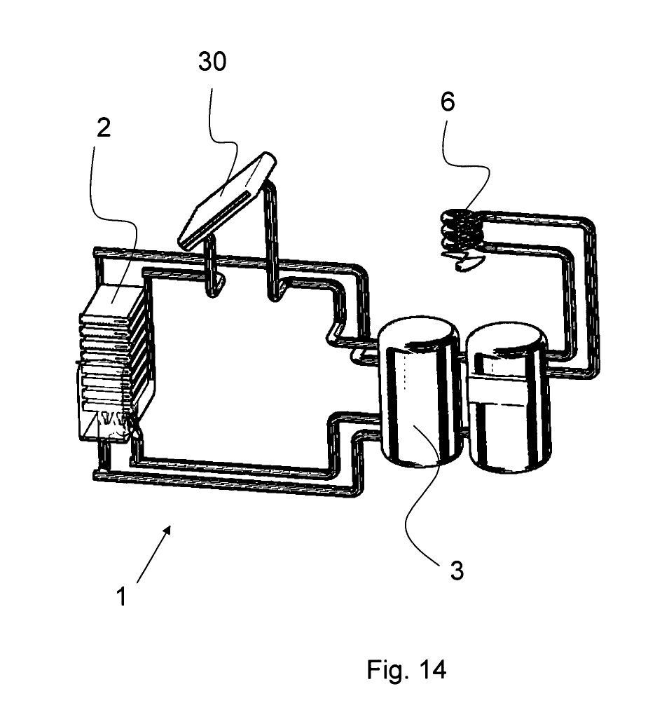

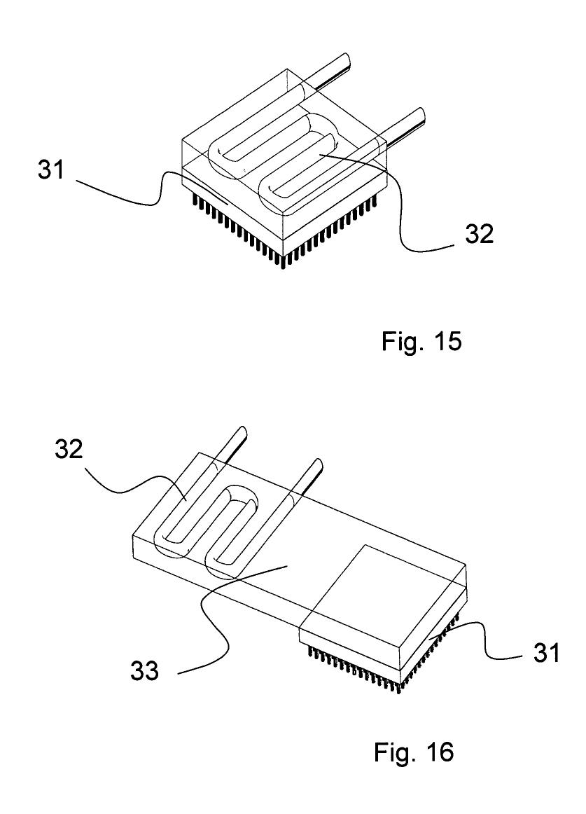

FIG. 15 schematically illustrates a detail of a processor cooling circuit.

FIG. 16 schematically illustrates processor cooling by means of a heat pipe.

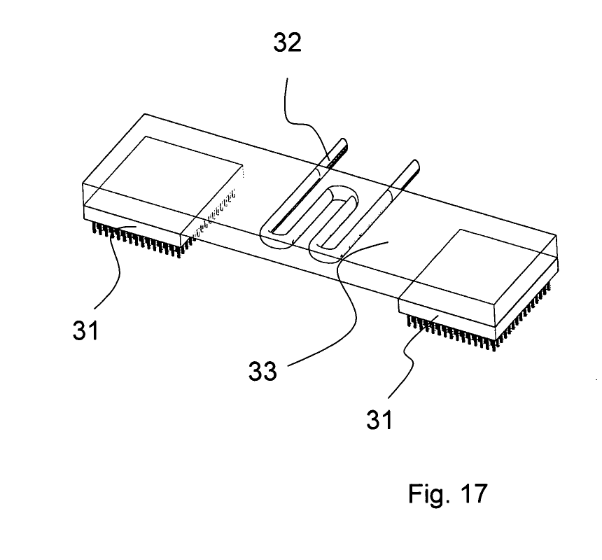

FIG. 17 schematically illustrates the coupling of two processors by means of a heat pipe or a thermally conductive material.

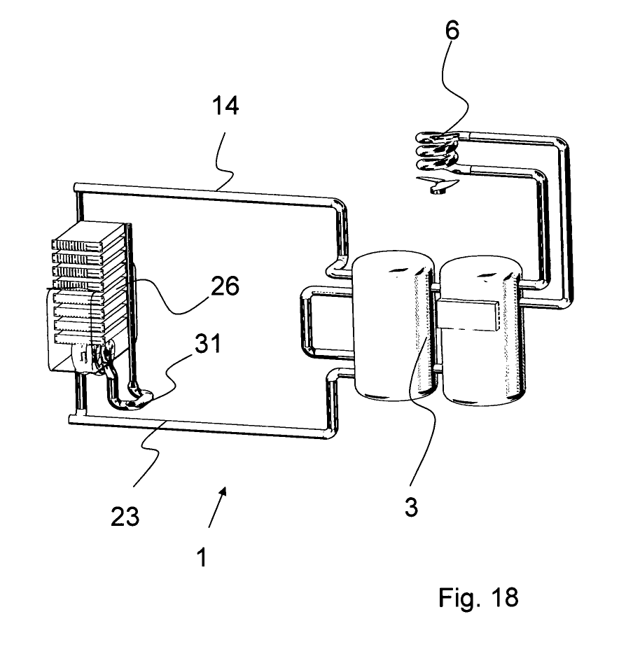

FIG. 18 schematically illustrates an embodiment of the invention including a closed cooling circuit.

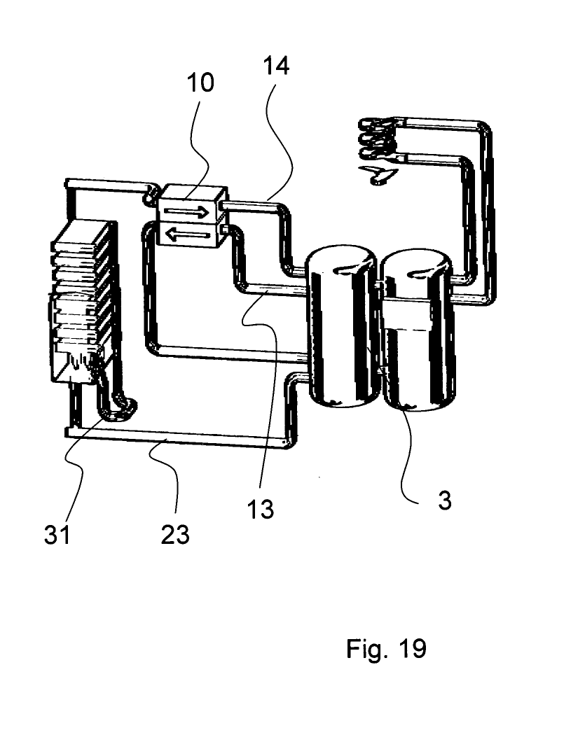

FIG. 19 schematically illustrates an embodiment of the invention including a cooling circuit for cooling racks and processors, with a heat pump interposed.

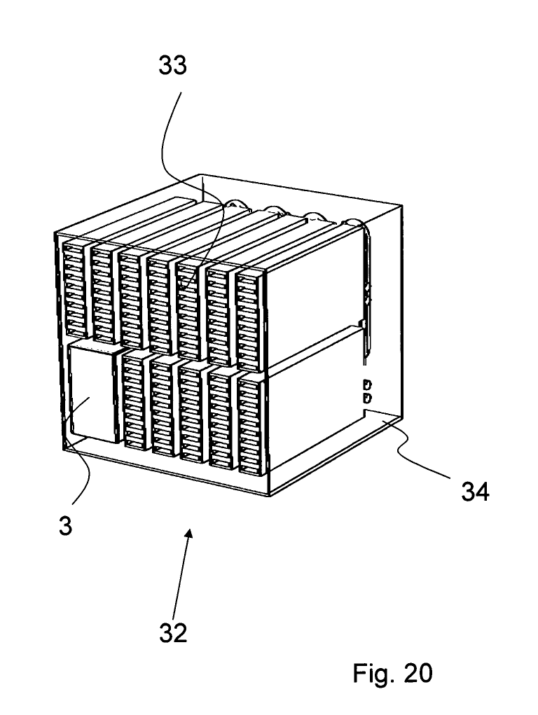

FIG. 20 schematically illustrates a blade server with integrated sorption refrigeration machine.

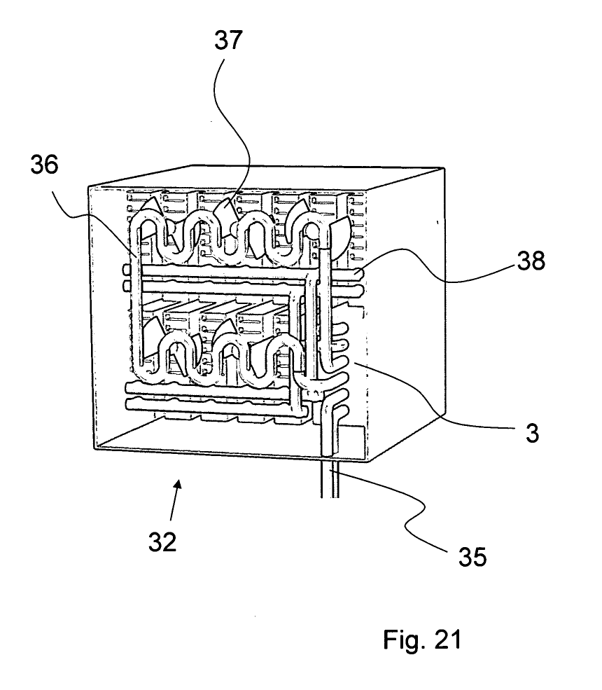

FIG. 21 shows the back of the blade server illustrated in FIG. 20.

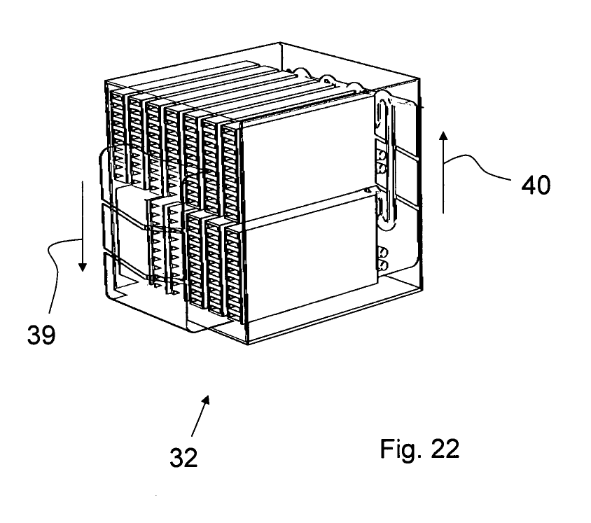

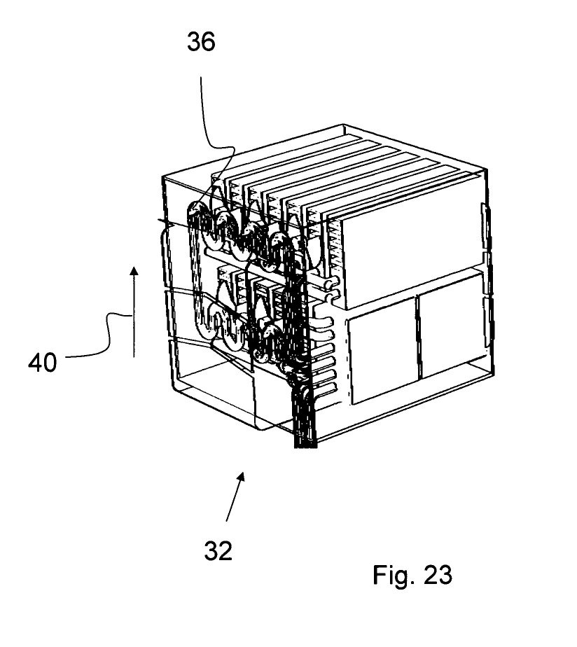

FIGS. 22 and 23 schematically illustrate the air circulation in a blade server.

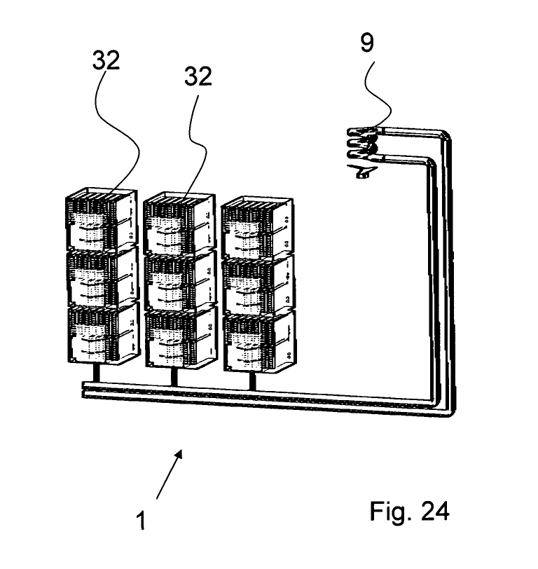

FIG. 24 shows a computing system including a plurality of blade servers.

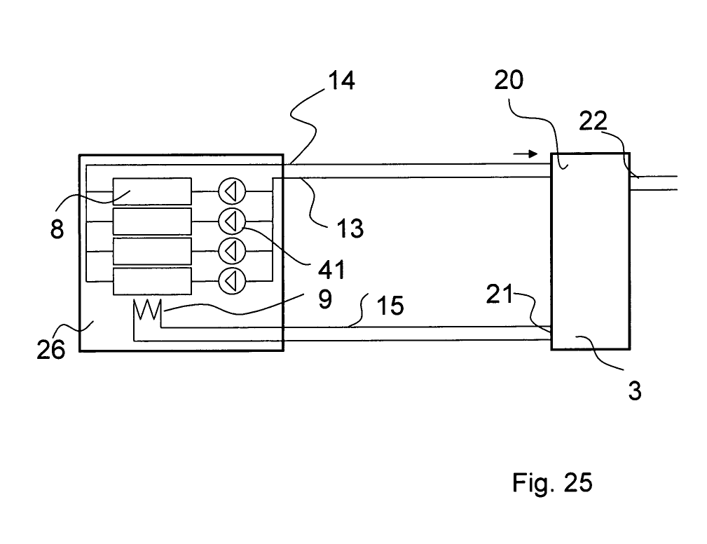

Referring to FIGS. 25 through 29, several ways to control the system according to the invention will be explained.

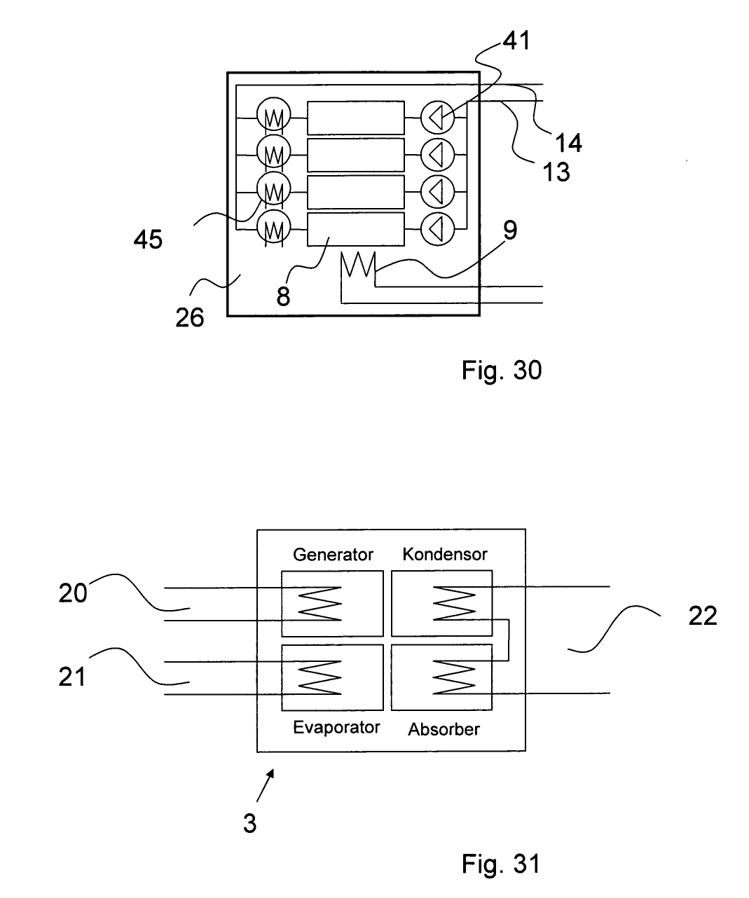

FIG. 30 shows a rack with integrated heating elements.

FIG. 31 schematically illustrates a sorption refrigeration machine.

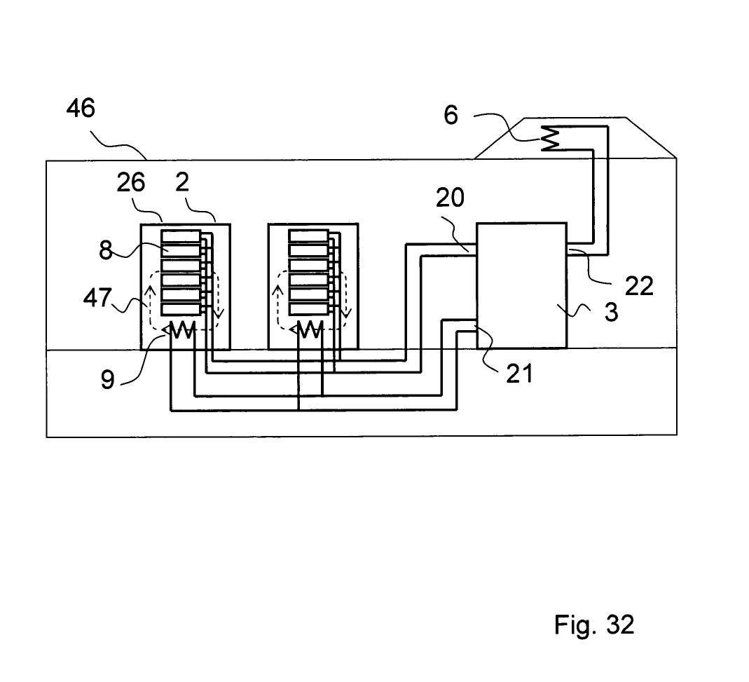

FIG. 32 shows a data processing center including a system for cooling a computing system.

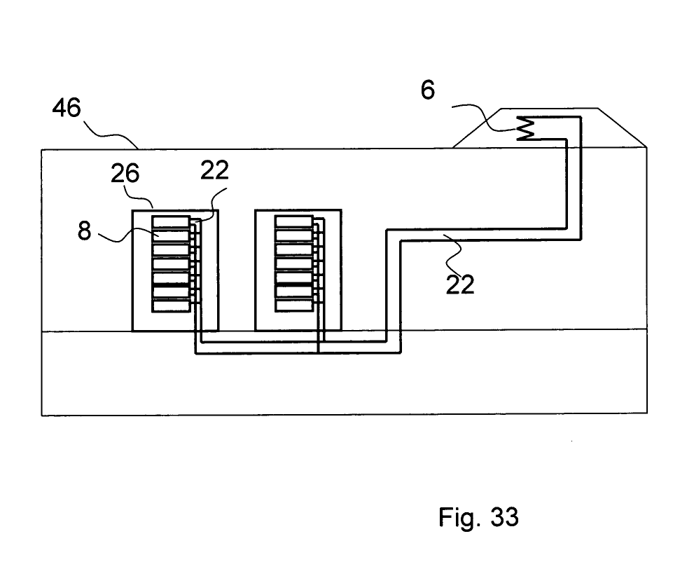

FIG. 33 shows another embodiment of a data processing center with integrated sorption refrigeration machines.

### DETAILED DESCRIPTION OF THE DRAWINGS

FIG. 1 schematically illustrates a first embodiment of the invention in which the system 1 for cooling a computing system 2 comprises a processor cooling circuit.

Computing system 2, here, is only schematically represented as a single rack that includes individual stacked modules 8 which are configured as a server, for example.

In this embodiment of the invention, the processors (not shown) of the computing system are cooled using a liquid. One advantage of directly cooling processors by means of liquids is the better cooling efficiency as compared to air or liquid cooled racks, which results in a higher amount of dischargeable heat.

To this end, cooling water at a temperature of less than 60° C. is fed to the processors via a feed flow line 4.

It will be understood that in practice a plurality of racks may be provided and that the system further comprises branched lines, valves, pumps, etc., which are not shown in this schematic illustration.

The cooling liquid heats up to a temperature of more than 60° C. and leaves the computing system 2 via a return flow line 5. Return flow line 5 of the computing system simultaneously constitutes the feed flow line of the hot section of a sorption refrigeration machine 3. Sorption refrigeration machine 3 may in particular be configured as an adsorption or absorption refrigeration machine.

A sorption refrigeration machine has a hot section 20, a cold section 21, and usually a waste heat section 22 (process heat). Energy is extracted from cold section 21 and is supplied to waste heat section 22. Accordingly, a fluid passed through cold section 21 cools down, whereas a fluid passed through waste heat section 22 heats up. In hot section 21, the thermal energy driving this process is supplied via a driving fluid, wherein this fluid passed through this hot section 21 cools down, whereas the fluid passed through waste heat section 22 heats up.

The heat supplied via return flow line 5 of computing system 2 serves as the driving energy for the sorption refrigeration machine and, after having emitted heat, is supplied to the cold section of sorption refrigeration machine 3 and exits the sorption refrigeration machine via a return flow line which at the same time forms the feed flow line 4 of computing system 2. For discharging the process heat from waste heat section 22 of the sorption refrigeration machine, the process heat is fed to an external heat exchanger 6 whose cooling capacity is increased by a fan 7.

In this way, sufficient heat discharge from the system to the outside air is ensured. Cooling of the process heat may also be accomplished otherwise, what is represented here is only the principle of re-cooling.

In an alternative embodiment which is not shown here, a heat pump is additionally provided between computing system 2 and sorption refrigeration machine 3, which heat pump serves to increase the temperature of the feed flow line of sorption refrigeration machine 3.

By using the cooling fluid for providing the driving energy for the sorption refrigeration machine, pre-cooling of the cooling fluid from the computing system is already achieved before the cooling fluid is further cooled down in the cold section of the sorption refrigeration machine.

FIG. 2 shows an alternative embodiment in which the computing system 2 comprises a rack including a heat exchanger 9. So the rack is cooled by a liquid. In alternative embodiments of the invention (not shown), cooling of the rack may also be accomplished by other techniques, for example by heat exchangers adapted to the housing walls. Usually, a liquid cooled rack requires lower feed flow temperatures than is the case with a processor cooling circuit. An advantage of rack cooling is the increased cooling efficiency which allows to discharge a greater amount of heat compared to merely air cooled racks. An advantage compared to processor cooling is the better handling. The computing system is less likely to be damaged by leakage of the cooling fluid. Also, in case of processor cooling, overheat and damage of the system may already result after very short time in the event of a short-term failure of cooling.

It will be appreciated that the system may be supplied with other energy from external sources, for example via a thermal solar collector.

The embodiment of the invention shown in FIG. 2 requires a considerably lower temperature for the feed flow 4 of computing system 2 as compared to a processor cooling circuit, usually a temperature from 5° C. to 15° C., to provide for sufficient cooling of the modules arranged in the rack.

Generally, the coolant in heat exchanger 9 heats up to a temperature which does not significantly exceed 25° C.

Therefore, return flow line 5 of the computing system 2 is connected with a heat pump 10 which in the illustrated embodiment is in form of a compression-type refrigeration machine.

Heat pump 10 includes a condenser 11, which forms the hot section, and an evaporator 12 which forms the cold section. Through heat pump 10 and the coolant supplied from return flow line 5 of the computing system 2, the driving fluid for the sorption refrigeration machine is brought to temperature sufficiently high for sorption refrigeration machine 3, and is supplied to sorption refrigeration machine 3 as driving energy via the feed flow line 14 of sorption refrigeration machine 3, which at the same time forms the return flow line of the hot section of heat pump 10.

Via return flow line 13 of the hot section of sorption refrigeration machine 3, the cooled-down driving fluid is returned to the hot section of heat pump 10 and is re-heated. The energy necessary therefore is extracted from the cooling liquid of the computing system, in evaporator 12, before the cooling liquid is supplied to the cold section of refrigeration machine 3, via the return flow line of the evaporator, which at the same time is the feed flow line 15 of the cold section of sorption refrigeration machine 3.

So the cooling circuit of computing system 2 is connected with the cold section of heat pump 10, and the circuit of the driving fluid of sorption refrigeration machine 3 is connected to the hot section of the heat pump. Thus, the driving fluid of sorption refrigeration machine 3 is brought to a sufficiently high temperature, by heat pump, in order to be used as driving energy in the hot section of the sorption refrigeration machine, and simultaneously the cooling fluid of computing system 2 is pre-cooled in the cold section of heat pump 10, before it is further cooled down in sorption refrigeration machine 3.

The cooling liquid cooled to below 10° C. for example, passes through the return flow line of the cold section of sorption refrigeration machine 3 to reach computing system 2.

It will be understood that also in this embodiment further energy from external sources may be supplied to the system, for example from a thermal solar collector.

FIG. 3 shows another embodiment of the invention in which the computing system 2 is cooled by air.

For this purpose, air is set into motion by fans 18 and 19 and is supplied to computing system 2 via feed flow 4.

Via return flow 5, the heated air is first passed through a first heat exchanger 16 which is coupled with the cold section, i.e. evaporator 12, of a heat pump 10. Heat exchanger 16 extracts heat from the air, and in the hot section, i.e. condenser 11, of heat pump 10, the driving fluid of the sorption refrigeration machine is brought to a sufficiently high temperature in order to be used as driving energy in the hot section of the sorption refrigeration machine.

Then, the already pre-cooled air is passed through a second heat exchanger 17 which is coupled with the cold section of sorption refrigeration machine 3. Via heat exchanger 17, the already pre-cooled air is brought to a sufficiently low temperature to be re-supplied, via feed flow line 4, to the computing system to cool it.

It will be understood that also in this embodiment further energy from external sources may be supplied to the system.

FIG. 4 shows another embodiment of a system 1 for cooling a computing system. Here, the hot section of a sorption refrigeration machine 3 is preferably coupled, via a liquid cooling circuit, to the processors of a computing system 2.

This cooling circuit supplies driving energy for sorption refrigeration machine 3 and may be operated at a high feed flow temperature of about 60° C. and a correspondingly high return flow temperature.

The cold section of sorption refrigeration machine 3 is coupled to another cooling circuit via heat exchanger 16. Here, the air which flows through the racks, is cooled by the heat exchanger. Process heat is discharged via another heat exchanger 9. An advantage of this system is that the sorption refrigeration machine can be operated at a particularly high ΔT.

FIG. 5 shows another embodiment of the invention in which sorption refrigeration machine 3 is provided with two interfaces for cooling.

In this embodiment, again, the hot section of sorption refrigeration machine 3 is coupled with the processors of the computing system via a liquid cooling circuit.

The cold section of sorption refrigeration machine 3 is connected with a heat exchanger 16 integrated in a rack, via another cooling circuit, i.e. the second interface. Through heat exchanger 16 the rack is cooled, that means the electronic components provided in the rack are cooled by a closed air circulation produced within the rack. In this embodiment, again, process heat is discharged via an external heat exchanger 9.

The return flow line 13 of the hot section of the refrigeration machine, which corresponds to the feed flow line of the processor cooling circuit of the computing system can be operated at a temperature above 50° C., whereas the return flow line 23 of the cold section of the refrigeration machine, through which the heat exchanger 16 is supplied with cold, is operated at a temperature below 20° C.

FIG. 6 shows another embodiment of the invention in which the refrigeration machine has two interfaces for cooling.

Sorption refrigeration machine 3 is coupled with the processors of computing system 2 via a first cooling circuit, again a liquid cooling circuit.

Through this first cooling circuit, sorption refrigeration machine 3 is supplied with heat as driving energy.

The cold section of refrigeration machine 3 serves to cool components that are not coupled with the first cooling circuit. In this exemplary embodiment, the rack is supplied with cooling air which is pre-cooled, after having left the rack, by means of a heat exchanger 16 that is connected to the cold section of sorption refrigeration machine 3, so that this air can be emitted into the room (not shown) in which the computing system is arranged.

In an alternative embodiment (not shown), the air is cooled before entering the rack.

FIG. 7 shows an embodiment of the invention in which the computing system 2 comprises a rack with a plurality of modules 8. In this exemplary embodiment, a sorption refrigeration machine 3 is provided which is integrated into the rack or directly coupled with the rack, and the sorption refrigeration machine is coupled with the processors of computing system 2 via a liquid coolant in first cooling circuit 24. Via a second cooling circuit 25 which operates at substantially lower temperature, a heat exchanger 16 is operated, which cools the components of the rack which are not cooled by the first cooling circuit.

An advantage of this arrangement is that it only requires one external connection for discharging process heat to heat exchanger 9. Furthermore, the heat can be cooled precisely at its source.

FIG. 8 shows another embodiment of the invention, in which a sorption refrigeration machine 3 is coupled with the processors of a computing system 2 via a first cooling circuit 24. Through cooling circuit 24, sorption refrigeration machine 3 is supplied with driving energy.

Cooling circuit 25 of the cold section is first connected with a cooling circuit of a rack of computing system 2 via a first heat exchanger 16.

Then, the cooling liquid is directed to another heat exchanger 17, which provides cooling air for a second rack or, for example, a telecommunications equipment.

FIG. 9 shows another embodiment of the invention in which, again, sorption refrigeration machine 3 is supplied with driving energy via a first cooling circuit 24. Via cooling circuit 25, both the rack of computing system 2 and another rack 26 are supplied with cooling liquid, which other rack may for example be part of a telecommunications equipment or may be another rack of a computing system (or another component of the computing system, such as a power supply). For this purpose, heat exchangers 16, 17 are provided in the racks.

FIG. 10 shows another embodiment of the invention. In this case, again, a first cooling circuit 24 is provided, which is connected to the hot section of refrigeration machine 3 to supply it with driving energy.

Another cooling circuit 25 which has a considerably lower feed flow temperature supplies a rack of computing system 2, via heat exchanger 16. The servers of rack 26, which may for example be a telecommunications equipment or the like, are directly supplied with liquid, via cooling circuit 25.

FIG. 11 shows another embodiment of the invention in which the hot section of sorption refrigeration machine 3 is coupled with the processors of computing system 2 via liquid cooling circuit 24.

Via cooling circuit 25, heat exchangers 16 and 17 of the computing system and of another rack 26 are supplied with cooling liquid.

Moreover, system 1 comprises an interface 27 through which the process heat can be removed and can be connected for example to the building heating or hot water supply of a building.

FIG. 12 shows an embodiment of a system 1 for cooling a computing system, which comprises a sorption refrigeration machine 3.

In this exemplary embodiment, the return flow line of a liquid cooling circuit for a computing system 2 is first connected to the hot section 20 of sorption refrigeration machine 3. In this way, sorption refrigeration machine 3 is supplied with driving energy.

After leaving the hot section 20 of sorption refrigeration machine 3, the cooling fluid is passed through a heat exchanger 28 and cooled down, for example to a temperature below 25° C. The already pre-cooled fluid is then supplied to cold section 21 and cooled down to a temperature below 15° C., to be then re-supplied to computing system 2 as a cooling medium. Process heat of sorption refrigeration machine 3 is discharged via heat exchanger 6.

Thus, in this exemplary embodiment heat exchanger 28 serves to cool down the still relatively warm fluid that leaves the hot section 20 of sorption refrigeration machine 3 to a sufficient temperature so that the cold section 21 of sorption refrigeration machine 3 is efficient enough to cool down the fluid to the desired feed flow temperature for computing system 2.

It will be understood that the heat exchanger 28 may also constitute a part of another, for example conventional, compressor-type refrigeration machine (not shown). In this case, the integration of sorption refrigeration machine 3 primarily serves to improve efficiency.

FIG. 13 shows another embodiment of the invention in which the system 1 for cooling a computing system comprises a sorption refrigeration machine 3 whose cold section 21 is coupled with a circuit which in this embodiment cools the racks of computing system 2.

The hot section 20 of the sorption refrigeration machine is coupled, via another, liquid-based cooling circuit, with computing system 2, in particular with the processors thereof. Similarly to other exemplary embodiments, the cooling circuit of the hot section 20 has substantially higher feed flow and return flow temperatures than the cooling circuit of cold section 21. The return flow of hot section 20 of sorption refrigeration machine 3 is fed to an interface 27, to which for example a heat exchanger may be connected, or which in particular is used for hot water supply of the building, since at interface 27 a fluid exits which has a relatively high temperature, in particular a temperature above 50° C.

The process heat from sorption refrigeration machine 3 is discharged via another interface 29. The feed flow temperature of interface 29 is usually not much above 35° C., so that interface 29 is particularly suitable to be connected to a low temperature heating circuit of a building, such as a panel heating system, in particular a floor heating or wall heating system.

FIG. 14 shows another embodiment of the invention in which the system 1 for cooling a computing system comprises a solar module 30 which is integrated into the cooling circuit of the hot section of the computing system, increases the feed flow temperature for the hot section and so provides additional driving energy. The racks of computing system 2 are supplied with cooling liquid via the cold section of sorption refrigeration machine 3. Process heat is discharged via heat exchanger 6.

FIG. 15 schematically illustrates a processor 31 with liquid cooling, the waste heat therefrom being supplied to a refrigeration machine as driving energy. For this purpose, the processor 31 is equipped with a cooling coil 32 at its back face, through which a cooling fluid can be circulated, in particular water. Cooling coil 32 is embedded into a thermally conductive material, or a thermally conductive material, for example aluminum, with integrated cooling coil may be applied to the back of the processor. Thus, the principle of processor cooling is illustrated here.

FIG. 16 shows another embodiment in which processor 31 is coupled with the cooling coil 32 via a heat pipe 33 or thermally conductive material. Heat pipe 33, in this exemplary embodiment, comprises a thermally highly conductive material such as aluminum, or comprises a cavity in which a liquid removes the heat by being evaporated at the processor side and condensing at the cold side. Thus, another embodiment of processor cooling is illustrated here.

FIG. 17 shows another embodiment of the invention in which a plurality of processors or other heat generating devices are thermally coupled with each other by a heat pipe 33 or a thermally conductive material. Cooling coil 32 by means of which the cooling fluid is supplied to a refrigeration machine as driving energy is arranged in the heat pipe between processors 31. An advantage of coupling a plurality of processors is that the complexity for providing the heat exchangers, here in form of cooling coil 32, is reduced. So, this illustrates yet another embodiment of processor cooling.

FIG. 18 schematically illustrates an embodiment of the invention in which a liquid is used as a cooling medium, and in which the computing system which comprises a rack 26, is equipped with a rack cooling system.

In this embodiment, first cold cooling fluid is directed via return flow line 23 of the cold section of the refrigeration machine through a heat exchanger of the rack cooling system. Usually, the cooling fluid has a temperature below 20° C.

By circulating air that flows along the heat exchanger, the rack is cooled. Then the rack cooling return flow 31 in which the cooling fluid has now a temperature above 20° C. is supplied to a processor cooling feed flow. An advantage thereof is that the processor cooling copes with a much higher feed flow temperature than the rack cooling.

Then the cooling fluid is supplied to sorption refrigeration machine 3, via feed flow line 14 of the hot section of the refrigeration machine, to be then fed to the cold section after having released driving energy.

Process heat is discharged via heat exchanger 6.

FIG. 19 shows another embodiment of the invention, which is principally based on FIG. 18.

Here, again, the return flow line 23 of the cold section of the refrigeration machine is connected with a heat exchanger of a rack cooling system, and the return flow line 31 of the rack cooling system is used to cool the processors.

In this embodiment, additionally, a heat pump 10 is interposed. Through the hot section of heat pump 10, the cooling fluid coming from processor cooling is further heated, and is supplied to the sorption refrigeration machine 3, via feed flow line 14 of the hot section of the refrigeration machine. In this manner, a high temperature can be ensured to provide the driving energy.

The return flow 13 of the hot section of the refrigeration machine is connected with the cold section of heat pump 10. Accordingly, now the cooling fluid, in particular the liquid, is further cooled down until it is again supplied to the cold section of sorption refrigeration machine 3 to be then cooled down further and then be returned to the rack cooling system. In this way, for example, an optimized, comparatively constant ΔT can be achieved, or a particularly high ΔT.

Thus, this embodiment of the invention also comprises a closed cooling circuit which is supported by heat pump 10.

FIG. 20 schematically illustrates a blade server. This is a system in which hardware components such as hard disk computer modules, graphics modules, telecommunications modules, etc. are inserted into the housing 34 of the blade server 32 as individual plug-in modules 33.

In this embodiment, the sorption refrigeration machine 3 is in form of a plug-in module. Specifically it is intended that the sorption refrigeration machine occupies at least two slots, since it generally take up some more space than a hard disk.

A significant advantage of this integration, besides the simple mounting, is that the paths for the cooling fluid are shorter.

FIG. 21 shows the rear side of the blade server schematically illustrated in FIG. 20.

The heat exchanger 36 for rack cooling can be seen, which is connected to sorption refrigeration machine 3. To support rack cooling, the blade server 32 comprises fans 37 which are disposed at the rear side and which are preferably also in form of plug-in modules. The individual modules of the rack, as required, may have connections 38 for processor cooling purposes, which are connected to the hot section or cold section of the sorption refrigeration machine 3, depending on the embodiment of the invention.

As a whole, only one port 35 is required for discharging the process heat. Referring to FIG. 22, the air flow within the rack will be explained.

As can be seen in FIG. 22 and FIG. 23, in this embodiment the air flows downwards at the front side 39 of the blade server, to flow upwards at the back side thereof passing heat exchanger 36.

An advantage of this embodiment is that the air flow may be configured such that it runs within the blade housing so that the blade is thermally neutral to the outside, i.e. besides any heat conduction through the housing walls no heat is released into the surrounding room.

Only one connection is required for process heat that is discharged, for example to the outside.

Therefore, depending on the building, air conditioning is not necessarily required to cool the room in which the servers are installed. This permits to expand data processing centers without any additional air conditioning.

FIG. 24 schematically illustrates a system 1 for cooling a computing system, which comprises a plurality of blade servers 32. The blade servers 32 are only coupled with an external heat exchanger 9 for discharging process heat.

Thus, at each rack that includes blade servers, only one connection is required for the cooling fluid.

Referring to FIG. 25, the configuration of a system for cooling a computing system will be described in more detail.

The system comprises a rack 26 which comprises a plurality of modules. Rack 26 is cooled through heat exchanger 9 which is connected with the cold section 21 of a sorption refrigeration machine 3. For this purpose, warm fluid, in particular liquid, is discharged via feed flow 15 of the cold section of the refrigeration machine, is cooled down, and is re-supplied to heat exchanger 9.

The individual modules 8 are provided with a processor cooling circuit.

In this exemplary embodiment, each module is coupled with a pump 41 through which the modules 8 are supplied with cooling liquid, via return flow line 13 of hot section 20 of the refrigeration machine. Via feed flow line 14 of the hot section of the refrigeration machine, the warm fluid is supplied to sorption refrigeration machine 3 as driving energy.

Any compensation reservoirs for the liquid cooling medium that might be necessary depending on the configuration of the system are not shown here.

By evaluating temperature sensors (not shown), the pumps 41 may be selectively controlled in a manner that each module 8 only gets the amount of cooling fluid it needs. At the same time it is ensured thereby that the temperature in the feed flow line 14 of the hot section of the refrigeration machine is substantially constant or at least does not fall below a certain threshold value so that the fluid could no longer be used as driving energy.

Process heat is discharged via waste heat section 22.

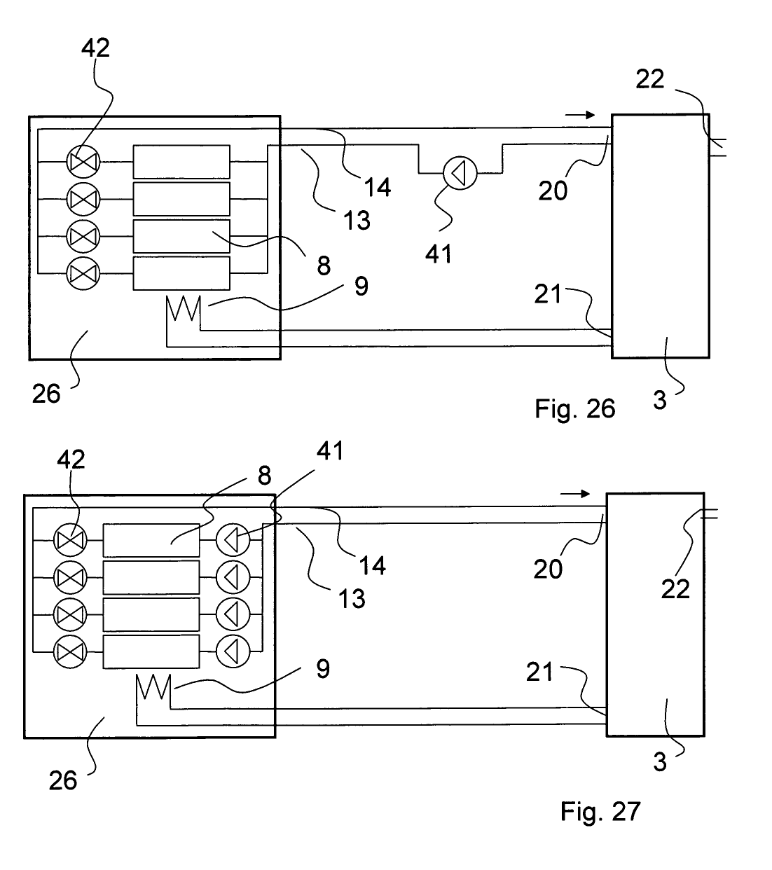

FIG. 26 schematically illustrates another embodiment in which the rack 26 again includes modules 8. In this embodiment, a central pump 41 is provided in the return flow line 13 of the hot section of the refrigeration machine through which the cooling fluid from the hot section 20 of sorption refrigeration machine 3 is distributed to the individual modules 8.

By means of valves 42 the return flow may be controlled such that it can be adjusted how much cooling fluid from which module 8 is supplied to the feed flow 14 of the refrigeration machine.

The rest of the configuration essentially corresponds to that of FIG. 25, in particular a heat exchanger 9 is provided for rack cooling, which is coupled with the cold section 21 of sorption refrigeration machine 3.

Process heat is discharged via waste heat section 22.

FIG. 27 shows another embodiment of the invention.

In this embodiment of the invention, again, a heat exchanger 9 is provided within rack 26, which heat exchanger is coupled with the cold section 21 of a sorption refrigeration machine 3.

Each module 8 has associated therewith a pump 41 and a valve 42, by which the flow rates of feed flow 14 and return flow 13 of the hot section 20 of the refrigeration machine may be controlled with respect to each individual module 8.

In this exemplary embodiment, again, the process heat is discharged via waste heat section 22.

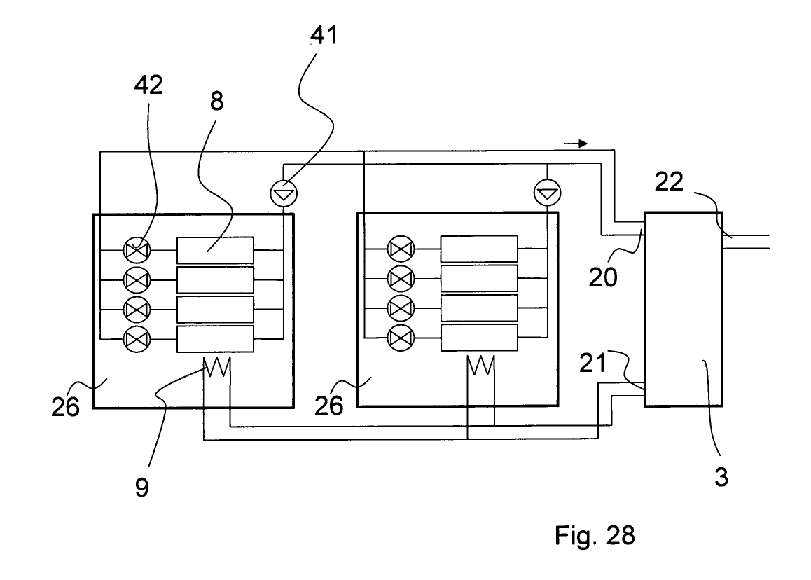

FIG. 28 shows another configuration in which a plurality of racks 26 are provided.

Each of the racks has a heat exchanger 9 which is connected with the cold section 21 of the sorption refrigeration machine and through which the air is cooled within the racks.

For each rack, a respective pump 41 is provided, through which the fluid from the return flow of the hot section 20 of sorption refrigeration machine 3 is supplied to the rack and distributes to modules 8 to cool the processors.

Each module has associated therewith a controllable valve 42, by means of which the flow rate may be controlled at the return flow side.

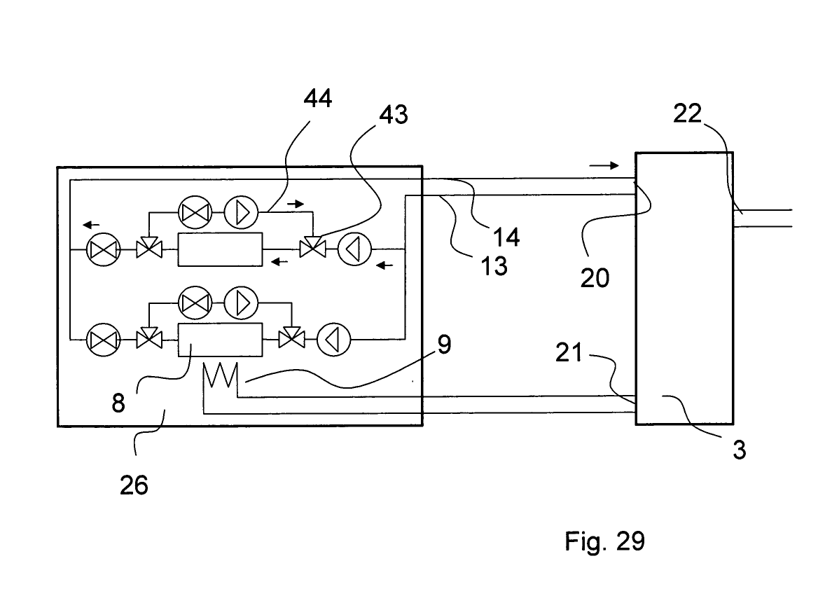

FIG. 29 shows another embodiment of the invention in which, again, a rack 26 is equipped with individual modules 8. The system comprises a heat exchanger 9 for rack cooling purposes, which heat exchanger is connected to the cold section 21 of sorption refrigeration machine 3.

In contrast to the embodiments illustrated before, a bypass 44 is provided for each module, via which cooling fluid may flow along the module bypassing it via a directional valve 43 or a T-shaped branching.

By means of a controllable bypass, a portion of the refrigerant which flows through the modules, may be returned in a circuit from the coolant outlet of the modules to the coolant inlet of the modules without being passed through the refrigeration machine. This allows to increase the amount of coolant flowing through the module, and so the temperature difference between coolant outlet and coolant inlet of the modules may be reduced without any need to increase the flow rate of the hot section of the sorption refrigeration machine. The bypass may for example be controlled in function of the individual load of the module and/or the individual temperature of the module, so that the individual module may influence the temperature at the coolant outlet and coolant inlet in function of the load and thereby adjusts the feed flow and return flow temperatures of the sorption refrigeration machine so as to be as optimally as possible for the sorption refrigeration machine. Since the efficiency of a sorption refrigeration machine is, among others, a function of the feed flow and return flow temperatures of the hot section and also of the temperature difference between the two, under certain operating conditions the bypass permits to improve the efficiency of the sorption refrigeration machine.

Furthermore, the bypass and the thereby enabled increase of the amount of coolant flowing through the module allow to achieve a more homogeneous temperature distribution among all the components connected to the processor cooling circuit.

In case of an operating state, for example, in which only one component out of a plurality of components connected to the processor cooling circuit of the module generates much heat energy to be dissipated, and the other components very little, overheating of the component in the individual module may be prevented by increasing the flow rate of the coolant without influencing the flow rate of the overall system.

It is also possible (not shown) that the bypass directs coolant to circumvent the module and thereby reduces the flow rate in the module without any need to reduce the flow rate at the hot section of the sorption refrigeration machine.

In this way, the system may adapt to changing computational loads or operating conditions by controlling the cooling fluid in the bypass.

The bypass and the amount of fluid flowing through the bypass may be adjusted by means of controllable valves and controllable pumps. Controlling (not shown) may be accomplished via the module or from outside the module, and temperature sensors (not shown) may also be involved.

It is also possible to provide a bypass for an entire rack (not shown) instead of those for individual modules. The operation thereof corresponds to that of an individual module's bypass.

Referring to FIG. 30, another embodiment of the invention will be explained in more detail, in which heating elements 45 are provided.

In this exemplary embodiment, again, a rack 26 is equipped with modules 8. The rack is provided with a rack cooling circuit which is operated via heat exchanger 9.

Return flow line 13 and feed flow line 14 of the hot section of a sorption refrigeration machine (not shown) are connected to modules 8 via a processor cooling circuit. For each module 8 a pump 41 is provided.

Each module 8 has associated therewith an electrical heating element 45 in the return flow line, by means of which the return flow temperature of modules 8 and thus the temperature of feed flow 14 of the refrigeration machine may be increased.

This ensures that the fluid supplied to the hot section of the refrigeration machine always has a sufficient temperature to be effective as a driving medium.

Furthermore, besides the temperature of the driving energy, the amount of driving energy for the sorption refrigeration machine may also be increased.

Instead by means of the heating elements, in another embodiment (not shown) the temperature or amount of driving energy may also be increased through the components coupled with the processor cooling circuit, namely by subjecting these components to higher loads using a software. In this case, no additional hardware components such as the heating elements are necessary.

Also conceivable is a variable distribution of the computational load, such that for example in case of a moderate load a part of the processors or servers may perform a large part of the required processing tasks and the cooling fluid is predominately directed via these processors. In this way, even in times of low utilization, a sufficiently high temperature for providing driving energy is achieved.

Referring to FIG. 31, a sorption refrigeration machine 3 is schematically illustrated.

As is known, sorption refrigeration machine 3 comprises the modules of a generator, condenser, evaporator, and absorber. Via a cooling circuit which passes through the condenser and absorber, process energy is discharged through waste heat section 22.

The evaporator forms the cold section 21, and the generator forms the hot section 20. Otherwise, the system of sorption refrigeration machines is generally known and needs no further explanation.

FIG. 32 schematically illustrates a data processing center 46.

Data processing center 46 generally comprises a room in which a computing system 2 is arranged, which in most cases includes a plurality of servers 26.

In this embodiment, a sorption refrigeration machine 3 is provided, which cools the servers by means of heat exchangers 9 which are connected to the cold section 21 of the refrigeration machine. For this purpose, air circulates through heat exchangers 9 within servers 26. The air flow 47 is indicated by arrows.

Individual modules 8 are arranged within servers 26, which modules are provided with a processor cooling circuit that is connected to the hot section 20 of refrigeration machine to provides it with driving energy.

Only heat exchanger 6 through which the process heat is discharged to the outside should be arranged outside the building.

It will be understood that instead to a heat exchanger, the process heat may likewise be fed into the building heating or hot water supply.

FIG. 33 shows another embodiment of a data processing center. In contrast to FIG. 32, here the sorption refrigeration machines are integrated in modules 8. Similarly an embodiment would look like in which the sorption refrigeration machines are integrated into the racks 26 or arranged adjacent to the racks or modules (not shown).

Here, it is only necessary to discharge the process heat via waste heat section 22 for which the modules 8 have a port.

A refrigeration machine or air conditioner outside the racks is not required, also the room does not necessarily require an air conditioner because the servers are almost thermally neutral.

A particular advantage of this embodiment is that in case of enlargements by adding servers, racks, or modules, the climate control does not require adaptation (with the exception of, in this example, the process heat discharged via heat exchanger 6).

The invention enables to considerably reduce the power consumption required for cooling a computing system.

### LIST OF REFERENCE NUMERALS

1 System
2 Computing system
3 Sorption refrigeration machine
4 Feed flow line
5 Return flow line
6 Heat exchanger
7 Fan
8 Module of computing system
9 Heat exchanger
10 Heat pump
11 Condenser
12 Evaporator
13 Return flow line of hot section of refrigeration machine
14 Feed flow line of hot section of refrigeration machine
15 Feed flow line of cold section of refrigeration machine
16 Heat exchanger
17 Heat exchanger
18 Fan
19 Fan
20 Hot section
21 Cold section
22 Waste heat section
23 Return flow line of cold section of refrigeration machine
24 Cooling circuit
25 Cooling circuit
26 Rack
27 Interface
28 Heat exchanger
29 Interface
30 Solar module
31 Return flow line of rack cooling circuit
32 Blade server
33 Plug-in module
34 Housing
35 Port process heat
36 Heat exchanger
37 Ventilation
38 Port processor cooling circuit
39 Air flow front
40 Air flow back
41 Pump
42 Valve
43 Bypass
44 Directional valve
45 Heating element
46 Data processing center
47 Air flow

1-42. (canceled)

43. A system for cooling a computing system, comprising a refrigeration machine by which a fluid is coolable, which fluid is suppliable to the computing system, wherein waste heat from the computing system is suppliable to the refrigeration machine to supply the refrigeration machine with driving energy, at least partially, via heat conduction or a liquid.

44. The system for cooling a computing system as claimed in claim 43, wherein the refrigeration machine is a sorption refrigeration machine.

45. The system for cooling a computing system as claimed in claim 43, wherein racks or processors or power components of the computing system are coolable by means of a liquid, wherein the liquid is suppliable to the refrigeration machine to drive it.

46. The system for cooling a computing system as claimed in claim 43, wherein the refrigeration machine is connected with a cooling circuit of the computing system via a heat exchanger.

47. The system for cooling a computing system as claimed in claim 43, wherein a heat pump is provided between the computing system and the refrigeration machine to increase the feed flow temperature of the refrigeration machine.

48. The system for cooling a computing system as claimed in claim 47, wherein the cold section of the heat pump is connected with the feed flow line of the cold section of the refrigeration machine.

49. The system for cooling a computing system as claimed in claim 47, wherein the return flow of the computing system is first passed through the cold section of the heat pump and then through the cold section of the refrigeration machine.

50. The system for cooling a computing system as claimed in claim 43, wherein the system includes means for selectively distributing the cooling fluid within the computing system.

51. The system for cooling a computing system as claimed in claim 43, wherein the system includes redundantly configured pumps for distributing the cooling fluid.

52. The system for cooling a computing system as claimed in claim 43, wherein the system comprises control electronics with an interface for connecting the computing system.

53. The system for cooling a computing system as claimed in claim 43, wherein the system comprises a cooling module in which at least the refrigeration machine and an electronic controller is arranged.

54. The system for cooling a computing system as claimed in claim 43, wherein the computing system is coolable through the refrigeration machine.

55. The system for cooling a computing system as claimed in claim 43, wherein a hot section of the refrigeration machine is connected with the computing system via a first circuit for supplying driving energy, and wherein the cold section of the refrigeration machine is connected with another cooling circuit of the computing system.

56. The system for cooling a computing system as claimed in claim 55, wherein the feed flow temperature of the first circuit differs from the feed flow temperature of the other cooling circuit by at least 20° C.

57. The system for cooling a computing system as claimed in claim 55, wherein the hot section of the refrigeration machine is connected, via a liquid cooling circuit, with processors or power components of the computing system, and wherein the cold section is connected with racks of the computing system, via an air or liquid cooling circuit.

58. The system for cooling a computing system as claimed in claim 43, wherein a section of the refrigeration machine through which process heat is dischargeable is connected to the heating system of a building, to a hot water supply, or to a power generator.

59. A system for cooling, comprising a refrigeration machine which is suppliable with waste heat as driving energy via a cooling circuit, wherein a fluid of the cooling circuit after having passed through a hot section of the refrigeration machine, is coolable via a heat exchanger, and wherein the fluid after having passed through the heat exchanger is suppliable to a cold section of the refrigeration machine.

60. The system for cooling a computing system as claimed in claim 59, wherein the waste heat of a plurality of processors is suppliable to the refrigeration machine as driving energy, wherein the processors are thermally coupled.

61. The system for cooling a computing system as claimed in claim 59, wherein the computing system includes at least one heating element for heating the fluid in a cooling circuit.

62. The system for cooling a computing system as claimed in claim 61, wherein at least one heating element is arranged in a server or a rack of the computing system.

63. The system for cooling a computing system as claimed in claim 62, wherein the sorption refrigeration machine is configured as a module which is insertable into the server.

64. The system for cooling a computing system as claimed in claim 59, wherein the system comprises a processor cooling circuit, and wherein processors. RAMs, chip sets, memory devices, power components of power supplies, power supplies, telecommunication devices or hard disks are coupled to a processor cooling circuit.

65. The system for cooling a computing system as claimed in claim 59, wherein the refrigeration machine is configured as a multiple-effect sorption refrigeration machine.

66. The system for cooling a computing system as claimed in claim 59, wherein the computing system and the refrigeration machine are arranged in a single room, and wherein the refrigeration machine is integrated into a component of the computing system or is arranged adjacent to a component of the computing system, and wherein there is no air conditioning provided to cool the room air.

67. A method for cooling a computing system, wherein a computing system is cooled by means of a sorption refrigeration machine, and wherein waste heat from the computing system is supplied to the sorption refrigeration machine as driving energy.
